(19) United States
(12) Patent Application Publication
(10) Pub. No.: US 2019/0228623 A1
(43) Pub. Date: Jul. 25, 2019

(54) ANTI-INTRUSION SECURITY DEVICE

(71) Applicant: SPECAT COMPANIES, San Francisco, CA (US)

(72) Inventors: Andrew P. Morrison, Santa Rosa, CA (US); William V. Morrison, San Francisco, CA (US); Matthew J. Lattig, The Plains, VA (US); David Hollister, San Francisco, CA (US); Ian Coats Maccoll, Mill Valley, CA (US); Alden Morris Mills, Kentfield, CA (US)

(73) Assignee: SPECAT COMPANIES, San Francisco, CA (US)

(21) Appl. No.: 15/879,622

(22) Filed: Jan. 25, 2018

(51) Int. Cl. G08B 13/08

(52) U.S. Cl. CPC G08B 13/08

(57) ABSTRACT

An anti-intrusion security device for attachment to a planar surface or personal article is described herein. In an example, the device may include a lower housing supporting a motion sensor, alarm and power source therein, and a cover adapted to be rotated about the lower housing between a plurality of actuator elements, each actuator element corresponding to a given operational state of the device. The sensor and alarm may be enabled for movement detection upon an actuator element corresponding to an ON state of the device being engaged by the rotating cover.

### BACKGROUND

### Field

The example embodiment in general is directed to an anti-intrusion security device.

### Related Art

A commonly used intrusion alarm system for detecting unauthorized entry into buildings is the electrically wired-type, wherein all doors and windows are wired together in one or more common circuits such that when the electrical circuit is broken, as could occur with an unauthorized entry, an alarm or signal device is activated. Such systems can be quite sophisticated, often incorporating fail-safe or anti-defeat circuitry whereby a high degree of reliability is provided. However, since skilled electricians are required to install and service these systems and since local building codes often impose expensive restrictions on wiring buildings, the installation and maintenance of such wire systems can be quite costly.

To reduce the comparatively high costs of such wire systems, various types of wireless systems are now employed, including the use of battery-powered radio transceivers at each of the doors and windows. However, wireless systems also can be comparatively expensive, since a separate battery-powered wireless transceiver is usually required for each window and door. A further disadvantage of these wireless systems is that the alarms may often be inadvertently triggered by spurious noise in the signals, since the more highly selective the system, the greater its cost and complexity.

### SUMMARY

An example embodiment is directed to an anti-intrusion security device. The device may include a lower housing supporting a motion sensor, alarm and power source therein, and a cover adapted to be rotated about the lower housing between a plurality of actuator elements, each actuator element corresponding to a given operational state of the device. The sensor and alarm may be enabled for movement detection upon an actuator element corresponding to an ON state of the device being engaged by the rotating cover.

Another example embodiment is directed to an anti-intrusion security device adapted for attachment to a planar surface or personal article. The device may include a lower housing including components integrated therein for detecting movement and emitting an audible alert upon movement detection, and an upper housing rotatable relative to the lower housing for selecting a plurality of operational states of the device. The components in the lower housing may be enabled for movement detection upon the upper housing being rotated so as to select an operational state of the device.

Another example embodiment is directed to an anti-intrusion security device. The device may include a first housing including components integrated therein for detecting movement and emitting an audible alert upon movement detection. The first housing may include a plurality of actuator elements corresponding to a plurality of operational states of the device. The device may include a second housing rotatable relative to the first housing for selecting a plurality of operational states of the device. The second housing may include a ramp element adapted to engage a given actuator element as the second housing is rotated relative to the first housing so as to select an operational state of the device.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a front plan view of an anti-intrusion security device according to the example embodiment.

FIG. 2 is a rear plan view of the cover of the device shown in FIG. 1.

FIG. 3 is a front plan view of the lower housing of the device shown in FIG. 1.

FIG. 4 is a front plan view of the device attached to a window.

### DETAILED DESCRIPTION

In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

In general, an example rotational resistance device as to be described in more detail hereafter is adapted for use against a flat surface such as a wall. Not only does the wall assist with balance and support for the user, but it also serves as a brace so that the user may selectively add sufficient resistance to the rotation of the device while maintaining their trunk and core stable (which cannot be accomplished otherwise). Example target areas which may be exploited by a user of the example rotational resistance device for exercise may include but are not limited to the muscles in and around the lower back, hips, core, knees, ankles, shoulders, elbows, and wrists. The example rotational resistance device is specifically adapted to the user based on physiology and biomechanics principles in order to facilitate injury prevention and rehabilitation after injury.

In general, the example embodiment as to be described in more detail hereafter operates by sensing an unauthorized motion with a motion sensor integrated into its singular, anti-intrusion security device. An audible alarm is emitted to deter further motion and draw attention to the security device so as to deter theft. The example security device is comparatively inexpensive to produce and has performance characteristics making it suitable to integrate into or attach to a planar surface such as a wall, window, or door. Moreover, the example anti-intrusion security device is attachable, such as by an adhesive, fasteners, or other like attachment means, to various personal articles including but not limited to: portable electronics such as a tablet or laptop computer, PDA, video camera, camera, and smart phone; jewelry such as a ring, watch, pendant; and personal articles such as a wallet, pen, key, key chain, coat, purse, and identification badges. The compact design of the inventive security device renders it amenable to retrofitting to an article or installation during the course of article manufacture.

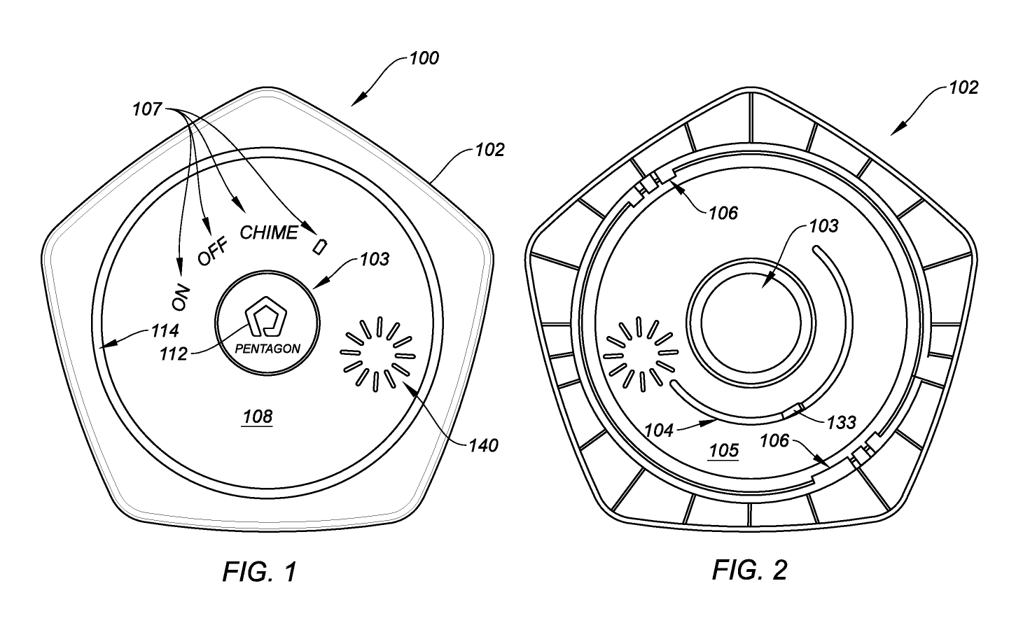

Referring to FIGS. 1-4, the basis of the device 100 is a motion sensor 125 (not shown, but integrated within device 100 as is known), which in a specific embodiment can be made using Micro Electro Mechanical Systems (MEMS) fabrication technology and is packaged into or otherwise integrated within the device 100. The components of device 100 include a cover 102 (upper or second housing) configured to be rotated relative to a lower housing to selectively engage one of a plurality of actuator elements 132. The lower housing 110 (first housing) is secure able within cover 102. The motion sensor 125, an alarm/sound system 140, and a power supply 150 which supplies a voltage to the motion sensor 125 and alarm 140 are each integrated within lower housing 110. Device 100 additionally includes an arm/disarm mechanism, which as to be described in further detail below includes the actuator elements 132 enagagable by a ramp element 133 traveling along a recessed, curved slot or track 134.

The security device 100, when armed and integrated into or attached on a planar surface or personal article, can sense motion. If motion is sensed, the alarm 140 is signaled; the alarm 140 can only be disarmed through the arm/disarm mechanism. Device 100 further includes a sensitivity switch 170. The sensitivity switch 170 is accessed on top surface 115, and may be actuated by the user to change sensitivity levels at which sensor 125 senses or detects movement between “NORMAL” and “SENSITIVE” modes.

An accelerometer is an electromechanical device used to measure acceleration forces. Such forces may be static, like the continuous force of gravity or, as is the case with many mobile devices, dynamic to sense movement or vibrations. Acceleration is the measurement of the change in velocity, or speed divided by time. For example, a car accelerating from a standstill to 60 mph in six seconds is determined to have an acceleration of 10 mph per second (60 divided by 6).

Accelerometers allow a user to understand the surroundings of an item better. An accelerometer enables one to determine if an object is moving uphill, whether it will fall over if it tilts any more, or whether it's flying horizontally or angling downward. For example, smart phones rotate their display between portrait and landscape mode depending on how the user tilts the phone.

An accelerometer consists of many different parts and works in many ways, two of which are the piezoelectric effect and the capacitance sensor. The piezoelectric effect is the most common form of accelerometer and employs microscopic crystal structures that become stressed due to accelerative forces. These crystals create a voltage from the stress, and the accelerometer interprets the voltage to determine velocity and orientation. The capacitance accelerometer senses changes in capacitance between microstructures located next to the device. If an accelerative force moves one of these structures, the capacitance will change and the accelerometer will translate that capacitance to voltage for interpretation.

Accelerometers are made up of many different components, and can be purchased as a separate device. Analog and digital displays are available, though for most technology devices, these components are integrated into the main technology and accessed using the governing software or operating system. Typical accelerometers are made up of multiple axes (x, y, z), two axes to determine most two-dimensional movement, with the option of a third axis for 3D positioning. The sensitivity of an accelerometer is quite high, as accelerometers are intended to measure even very minute shifts in acceleration. The more sensitive the accelerometer, the more easily it can measure acceleration.

Accordingly, the desired sensor arrangement for device 100 is one that detects motion. A MEMS construction may be desirable due to the consolidation of several advantages, such as the ability to sense motion accurately, minimal power consumption, and reduced dimensions. As is known, MEMS technology is applicable to accelerometers, gyroscopes, digital compasses, inertial modules, pressure sensors, humidity sensors and microphones. Specific MEMS-fabricated motion sensors applicable for integration into device 100 illustratively may include but are not limited to a strain-gauge accelerometer, a capacitive accelerometer, a force-balanced capacitive accelerometer, a piezoelectric accelerometer, a tunneling accelerometer, a latching accelerometer, an accelerometer switch array, a multi-axis accelerometer and a micro-machined gyroscope. However, other macroscopically fabricated motion sensors are applicable herein, such as tumbler switches, mercury switches, piezoresistive switches and/or any suitable device that detects motion and which may be integrated into device 100.

An example commercially-available accelerometer applicable for integration into device 100 as the motion sensor 125 may be the LIS2DE MEMS accelerometer by ST MICROELECTRONICS®, in either an analog or digital configuration within a 2×2×1 mm package size and including either a 14 or 12-lead pinout. Sensor 125 may include up to ±400 g acceleration full scale and a supply voltage from 1.71 to 3.6 V. Sensor 125 may also be configured with a low-power mode, auto wake-up function, and a FIFO buffer that can be used to store data, thus reducing host processor loading and system power consumption.

In an alternative embodiment, sensor 125 may be embodied as a high-accuracy proximity sensor having a supply voltage from 2.6 to 3.0 V, and which has a very low power consumption (<1 μA in standby mode, 1.7 mA during typical ranging operations). One commercially-available proximity sensor may be the VL6180X 3-in-1 time-of-flight (ToF) module by ST MICROELECTRONICS, which implements a patented technology called FLIGHTSENSE™ using ToF principles in its high-accuracy proximity sensors. The FLIGHTSENSE technology is based on a packaged sensor that integrates the proximity sensor's Single Photon Avalanche Diode (SPAD) array, Ambient Light Sensor (ALS) as well as the Vertical Cavity Surface-Emitting Laser (VCSEL) used by the proximity sensor, thus greatly easing product integration. This technology can be used in a host of application areas where accurate ranging is required.

In order to generate a loud sound using an extremely small device, a buzzer or piezoresistive buzzer may be employed as an example of an audible alarm 140. In an optional embodiment, an alternative notification means may further include a visual indication of the “armed” state and/or detection of motion by sensor 125, either singly or coupled with an audible alarm. The visual display may optionally be provided through a variable light emitting diode (LED).

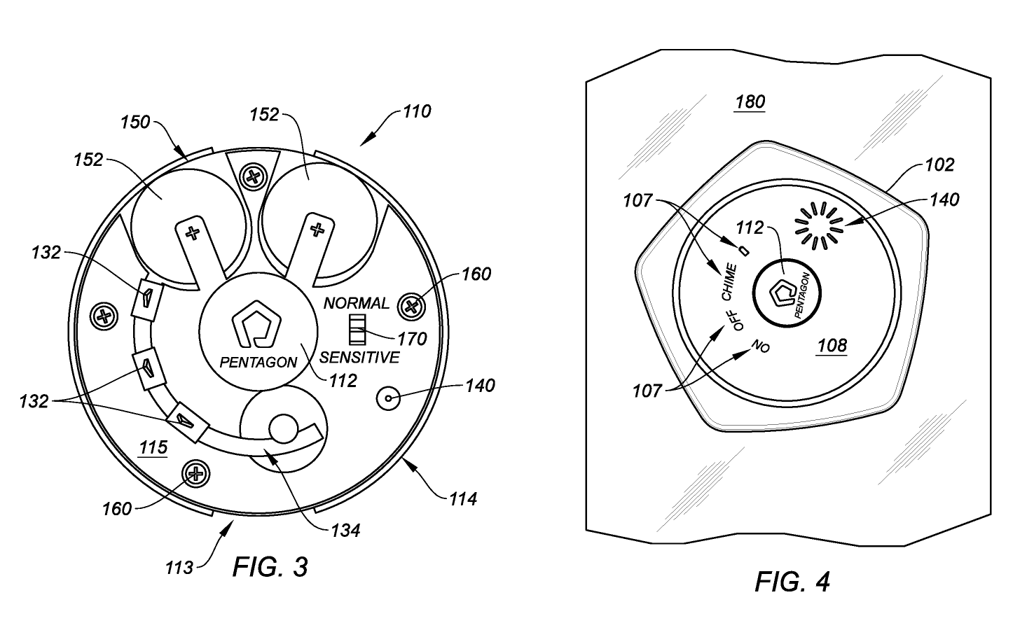

As can be seen best in FIG. 2, cover 102 includes a central aperture 103, and has a ramp 133 protruding therefrom; the ramp 133 is within a curved recess 104 formed in the inner surface 105 of cover 102. Referring to FIG. 3, the lower housing 110 includes a central stanchion 112 adapted to extend through the central aperture 103 of the cover 102, so that the cover 102 may be rotatable about the stanchion 112. The cover 102 includes a pair of latches 106 that align with openings 113 on the lower housing 110's periphery, rotation of cover 102 relative the lower housing 110 enables the latches 106 to engage circumferential lips 114 formed around the outer periphery of the lower housing 110 so as to secure the cover 102 to lower housing 110.

Lower housing 110 may be configured as a one or two-piece molded article; here shown as a two-piece article with the halves connected via a plurality of fasteners 160 (such as set screws). In general, the cover 102 and lower housing 110 may be formed by an injection molding process from a medium or heavy gauge impact plastic such as a thermoplastic elastomer (TPE) or acrylonitrile butadiene styrene (ABS). ABS is an easily machined, tough, low-cost, rigid thermoplastic material with medium to high impact strength, and is a desirable material for turning, drilling, sawing, die-cutting, shearing, etc.

TPE and ABS are merely example materials; equivalent materials include various thermoplastic and thermoset materials that have characteristics similar to TPE and ABS. For example, polypropylene, high-strength polycarbonates such as GE Lexan, and/or blended plastics may be used instead of, or in addition with TPE or ABS. The materials comprising device 100 provide a light yet durable device 100. An exemplary injection molding system for forming molded plastic articles included in device 100 may be the Roboshot® injection machine from Milacron-Fanuc. The Roboshot is one of many known injection molding machines for forming plastic injection molds.

The lower half of housing 110 contains the sensor 125 and alarm 140 circuitry integrated therein, as is known. The top surface 115 of lower housing 110 includes a plurality of actuator elements 132 arranged in spaced relation to one another within a curved track 134 that is recessed into the top surface 115 thereof. As will be discussed further below, ramp 133 is configured so as to travel within track 134 as cover 102 is rotated relative to lower housing 110.

In one example, the actuator elements 132 may be embodied as limit switches. A limit switch is an electromechanical device that consists of an actuator mechanically linked to a set of contacts. When an object (such as ramp 133) comes into contact with the actuator, the device operates the contacts to make or break an electrical connection. Limit switches may be used in a variety of applications and environments, including the example embodiments as described herein, because of their ruggedness, ease of installation, and reliability of operation. Limit switches may determine the presence or absence, passing, positioning, and end of travel of an object.

Standardized limit switches may be understood as industrial control components manufactured with a variety of operator types, including lever, roller plunger, and whisker type. Limit switches may be directly mechanically operated by the motion of the operating lever. In an example, a limit switch may be embodied as a reed switch, which is designed to indicate proximity of a magnet mounted on some moving part. In another example, a limit switch may be embodied as a proximity switch, operable due to the disturbance of an electromagnetic field, by capacitance, or by sensing a magnetic field.

Limit switches may be directly mechanically operated by the motion of the operating lever. In an example, a limit switch may be embodied as a reed switch, which is designed to indicate proximity of a magnet mounted on some moving part. In another example, a limit switch may be embodied as a proximity switch

The top surface 115 of lower housing 110 additionally supports a power supply 150 thereon that powers the motion sensor 125 and alarm 140; in an example the power supply 150 may be embodied by one or more button-cell batteries such as 3V 2032-series lithium battery cells 152.

The arm/disarmed mechanism consists of the actuator elements 132 in track 134, and the ramp 133 formed on the inner surface 105 of the cover 102. Each actuator element 132 represents a corresponding device 100 operational state: “OFF”, “ON” and “CHIME”, with indicia 107 corresponding to these states provided on the outer surface 108 of cover 102. A fourth position does not contain an actuator element 132; this position (a battery icon representing BATT REPLACE) enables latches 106 on cover 102 to align within openings 113 on the lower housing 110 so that the cover 102 may be removed to change out the button cells 152.

In operation, as a user rotates the cover 102 about stanchion 112 and relative to lower housing 110, the ramp 133 travels along track 134 to selectively engage a given actuator element 132 via contact, placing device 100 in the corresponding operational state. To facilitate proper engagement of ramp 133 to actuator element 132 (and hence the operational state of device 100), contact between ramp 133 and a given actuator element 132 generates an audible or tactile clicking sound. Accordingly, the rotation of the cover 102 about the stanchion 112 of lower housing 110 to or from the “ON” actuator element 132 position either enables or disables the motion sensor 125 and alarm 140. As alarm 140 is powered by power source 150, it is adapted to emit an audible alert signal through a speaker (not shown) upon receipt of a motion detect signal from sensor 125.

With the actuator element 132 corresponding to the ON state being engaged by ramp 133, the motion senor 125 and alarm 140 are enabled. Any movement thereafter detected by the motion sensor 125 will cause the alarm 140 to signal an alert. As an example, the sensor 125 may detect movement such as when a door or window (such as window 180 in FIG. 4) is being opened by a burglar, or a personal article being stolen by a thief. On detection, motion sensor 125 sends a motion detect signal to the alarm 140, and as alarm 140 is enabled, this will cause an audible alert from the speaker of device 100.

Although limit switches such as reed or proximity switches, and/or lever, roller plunger, and whisker type limit switches are applicable as an actuator element 132, the example embodiments are not so limited. Any device or actuator (e.g., mechanical, electromagnetic or electrical) which is adapted to cooperate with the ramp 133 may alternatively be included as part of the arm/disarmed mechanism.

The example embodiments having been described, it is apparent that such have many varied applications. For example, the example embodiments may be applicable but not limited to connection to various devices, structures and articles.

The present invention, in its various embodiments, configurations, and aspects, includes components, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices in the absence of items not depicted and/or described herein or in various embodiments, configurations, or aspects hereof, including in the absence of such items as may have been used in previous devices, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

We claim:

1. An anti-intrusion security device, comprising:
a lower housing supporting a motion sensor, alarm and power source therein, and
a cover adapted to be rotated about the lower housing between a plurality of actuator elements, each actuator element corresponding to a given operational state of the device, the sensor and alarm enabled for movement detection upon an actuator element corresponding to an ON state of the device being engaged by the rotating cover.

2. The device of claim 1, wherein
the lower housing includes a central, cylindrical stanchion, and
the cover includes a central circular aperture, the stanchion adapted to extend into the aperture so that the cover is rotatable relative to the lower housing

3. The device of claim 1, wherein an inner surface of the cover includes a ramp formed thereon, the ramp adapted to engage a given actuator element on the lower housing as the cover is rotated relative to the lower housing between operational states.

4. The device of claim 3, wherein contact of the ramp with a given actuator element is confirmed by a tactile clicking sound.

5. The device of claim 1, wherein the lower housing further includes a sensitivity switch to adjust the sensitivity of the motion sensor for detecting movement.

6. The device of claim 1, wherein the lower housing includes an adhesive on a rear surface thereof to facilitate device attachment to a planar surface or personal article.

7. The device of claim 6, wherein the planar surface is selected from a group consisting of a wall, a window, and a door.

8. The device of claim 6, wherein the personal article is selected from a group consisting of:
portable electronics such as a tablet or laptop computer, PDA, video camera, camera, and smart phone;
jewelry including a ring, watch, and pendant; and
personal articles including a wallet, pen, key, key chain, coat, purse, and identification badge.

9. The device of claim 1, wherein the motion sensor is a MEMS motion sensor.

10. The device of claim 9, wherein the MEMS motion sensor is selected from a group consisting of a strain-gauge accelerometer, a capacitive accelerometer, a force-balanced capacitive accelerometer, a piezoelectric accelerometer, a tunneling accelerometer, a latching accelerometer, an accelerometer switch array, a multi-axis accelerometer and a micro-machined gyroscope.

11. The device of claim 1, wherein the motion sensor is embodied as a motion sensitive switch selected from a group consisting of a tumbler switch, a mercury switch, and a piezoresistive switch.

12. The device of claim 1, wherein the power source is embodied by one or more button-cell batteries rated at 3V.

13. An anti-intrusion security device adapted for attachment to a planar surface or personal article, comprising:
a lower housing including components integrated therein for detecting movement and emitting an audible alert upon movement detection, and
an upper housing rotatable relative to the lower housing for selecting a plurality of operational states of the device, the components in the lower housing enabled for movement detection upon the upper housing being rotated so as to select an operational state of the device.

14. The device of claim 13, wherein the components integrated within the lower housing include a motion sensor.

15. The device of claim 14, wherein the motion sensor is embodied as a MEMS accelerometer having a supply voltage from 1.71 to 3.6 V and configured with a low-power mode, auto wake-up function, and a FIFO buffer.

16. The device of claim 14, wherein the motion sensor is embodied as a proximity sensor having a supply voltage from 2.6 to 3.0 V, and a power consumption of <1 μA in a standby mode and 1.7 mA during a typical ranging operation.

17. The device of claim 13, further comprising an arm/disarmed mechanism in the upper and lower housings.

18. The device of claim 17, wherein arm/disarmed mechanism further includes:
a ramp formed on an inner surface of the upper housing, and
a plurality of actuator elements corresponding to a plurality of operational states of the device and formed on a facing upper surface of the lower housing, the ramp adapted to engage a given actuator element as the upper housing is rotated relative to the lower housing between operational states.

19. The device of claim 13, wherein
the lower housing includes a stanchion, and
the upper housing includes an aperture, the stanchion adapted to extend into the aperture to facilitate rotation of the upper housing relative to the lower housing.

20. An anti-intrusion security device, comprising:
a first housing including components integrated therein for detecting movement and emitting an audible alert upon movement detection, the first housing including a plurality of actuator elements corresponding to a plurality of operational states of the device, and
a second housing rotatable relative to the first housing for selecting a plurality of operational states of the device, the second housing including a ramp element adapted to engage a given actuator element as the second housing is rotated relative to the first housing so as to select an operational state of the device.
